(19) United States
(12) Patent Application Publication
(10) Pub. No.: US 2018/0253659 A1
(43) Pub. Date: Sep. 6, 2018

(54) Data Processing System with Machine Learning Engine to Provide Automated Message Management Functions

(71) Applicant: Bank of America Corporation, Charlotte, NC (US)

(72) Inventors: Jisoo Lee, Chesterfield, NJ (US); Jason Daniel Latta, Charlotte, NC (US)

(21) Appl. No.: 15/448,205

(22) Filed: Mar. 2, 2017

(51) Int. Cl. G06N 99/00; H04L 12/58

(52) U.S. Cl. CPC G06N 99/005; H04L 51/24; H04L 51/16; H04L 51/02

(57) ABSTRACT

Aspects of the disclosure relate to implementing and using a data processing system with a machine learning engine to provide automated message management functions. In some embodiments, a computing platform having at least one processor, a memory, and a communication interface that may receive, via the communication interface, a plurality of messages corresponding to a messaging account. Next, the computing platform may monitor, via the communication interface, one or more user interactions with the plurality of messages. Subsequently, the computing platform may receive, via the communication interface, a new message. Responsive to receiving the new message, the computing platform may determine, based at least in part on the one or more user interactions with the plurality of messages, an opportunity to perform an automated message management action associated with the new message. Subsequently, the computing platform may perform the automated message management action.

### BACKGROUND

Aspects of the disclosure relate to electrical computers, data processing systems, and machine learning. In particular, one or more aspects of the disclosure relate to implementing and using a data processing system with a machine learning engine to provide automated message management functions.

Users of messaging services, such as email messaging services, chat messaging services, and the like, commonly receive large volumes of messages. Moreover, friends, colleagues, supervisors, and other contacts commonly expect users to be available via messaging services, even when users are busy. Managing, prioritizing, and responding to the large and growing volume of received messages remains an ever-present challenge for users.

### SUMMARY

Aspects of the disclosure provide effective, efficient, scalable, and convenient technical solutions that address and overcome the technical problems associated with receiving, managing, prioritizing, and responding to messages. In particular, one or more aspects of the disclosure provide techniques for implementing and using a data processing system with a machine learning engine to provide automated message management functions.

In some embodiments, a computing platform having at least one processor, a memory, and a communication interface may receive, via the communication interface, a plurality of messages corresponding to a messaging account. Next, the computing platform may monitor, via the communication interface, one or more user interactions with the plurality of messages. Subsequently, the computing platform may receive, via the communication interface, a new message. Responsive to receiving the new message, the computing platform may determine, based at least in part on the one or more user interactions with the plurality of messages, an opportunity to perform an automated message management action associated with the new message. Subsequently, the computing platform may perform the automated message management action.

In some embodiments, the computing platform may determine the opportunity to perform the automated message management action associated with the new message by analyzing the plurality of messages and the monitored one or more user interactions with the plurality of messages, training, based on the analysis, one or more machine learning models, and determining, based on analyzing the new message using the one or more machine learning models, the opportunity to perform the automated message management action associated with the new message.

In some embodiments, the computing platform may include one or more machine learning models configured to determine a priority score of the new message, the priority score indicating an importance of the new message to a user associated with the messaging account.

In some embodiments, the priority score may be based at least in part on a first position within an organization of a sender of the new message relative to a second position within the organization of the user associated with the messaging account. In some embodiments, the priority score may be based at least in part on one or more of a topic associated with the new message, one or more keywords within the new message, and a sentiment of the new message. In some embodiments, the priority score may be based at least in part on other recipients of the new message.

In some embodiments, the computing platform may perform automated message management actions including ranking the new message within the plurality of messages according to the priority score, generating an automatic response to the new message, automatically un-subscribing from a mailing list associated with the new message, automatically sending a notification to a user associated with the messaging account, the notification indicating that the user has not responded to the new message, categorizing the new message, suggesting one or more recipients to add to or remove from a response message to be sent in response to the new message, and/or generating a user interface comprising a summary of the new message and one or more summaries of other messages that are similar to the new message.

In some embodiments, the plurality of messages may comprise a first message, the monitored one or more user interactions may comprise a second message sent in response to the first message, and the computing platform may analyze the plurality of messages and the monitored one or more user interactions with the plurality of messages by determining a response time between receiving the first message and sending the second message, and determining, based on the response time, a priority associated with the first message.

In some embodiments, the computing platform may generate an automatic response including scheduling information describing an availability of a user associated with the messaging account.

In some embodiments, the computing platform may generate a user interface comprising a summary of the automated message management action, receive a user input indicating an approval of the automated message management action, and update, based on the user input, one or more machine learning models.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing and using a data processing system with a machine learning engine to provide automated message management functions in accordance with one or more example embodiments;

FIGS. 2A-2G depict an illustrative event sequence for implementing and using a data processing system with a machine learning engine to provide automated message management functions in accordance with one or more example embodiments;

FIG. 3 depicts an example organization hierarchy graph for implementing and using a data processing system with a machine learning engine to provide automated message management functions in accordance with one or more example embodiments;

FIGS. 4-9 depict example graphical user interfaces for implementing and using a data processing system with a machine learning engine to provide automated message management functions in accordance with one or more example embodiments;

FIG. 10 depicts an illustrative method for implementing and using a data processing system with a machine learning engine to provide automated message management functions in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to using machine learning to perform automated message management actions. In some instances, a message management computing platform may use one or more machine learning models to determine opportunities to perform automated message management actions. The message management computing platform may train the one or more machine learning models using a collection of data including past messages received and indications of how users managed the past messages. Accordingly, the message management computing platform may monitor user interactions with messages before training the one or more machine learning models, and may continue to monitor user interactions with messages in order to continue updating and/or retraining the machine learning models over time.

In some instances, the message management computing platform may analyze messages and/or monitored user interactions in order to learn how to identify opportunities to perform automated message management actions. In some instances, the message management computing platform may observe user interactions with messages in order to determine a priority a user assigns to a message by, for example, monitoring how long it takes a user to respond to a message and/or which message a user selects to view first. Based on the observations and on characteristics of corresponding messages, the message management computing platform may train machine learning models to estimate a priority for messages. Subsequently, after estimating a priority for a newly-received message, the message management computing platform may automatically manage the new message by, for example, ranking the new message based on its priority, notifying the user that a response to the new message has not yet been sent, un-subscribing from a mailing list associated with the message, and the like.

In some instances, the message management computing platform may monitor user responses to messages in order to learn to identify opportunities to generate and/or send automatic responses to messages. Based, for example, on a user commonly sending certain responses or certain types of responses to messages having certain characteristics, the message management computing platform may train one or more machine learning models to classify a message as an opportunity to generate and/or send an automatic response. Subsequently, the message management computing platform may determine whether to send the automatic response based on various contextual factors such as a priority associated with the message, whether the user is busy, whether the user has had time to respond to the message, and the like.

In some instances, the message management computing platform may monitor user categorizations and/or tags of messages in order to learn to identify opportunities to automatically categorize and/or tag messages. Based, for example, on a user commonly applying certain tags and/or categories to messages with certain characteristics, the message management computing platform may train one or more machine learning models to determine an opportunity to classify a message as belonging to a certain tag and/or category. Subsequently, the message management computing platform may apply the tags and/or categories to the message.

In some instances, the message management computing platform may monitor user interactions and analyze messages in order to find groups of messages with similar characteristics. Based on finding a group of messages with similar characteristics, the message management computing platform may combine the messages into groups, suggest new categories for the group of messages, suggest potential recipients of messages based on users that appear in similar messages, and/or generate summaries of groups of messages.

In some instances, the message management computing platform may analyze messages in order to determine their characteristics by identifying one or more senders and/or recipients of messages, identifying other metadata associated with messages such as message headers, and/or performing sentiment analysis, keyword analysis, and/or topic analysis on the content of messages. The analyzed characteristics of messages may be used as training data for training the machine learning models, and as input features to the machine learning models for determining scores and/or categorizations that indicate an opportunity to perform an automated message management action.

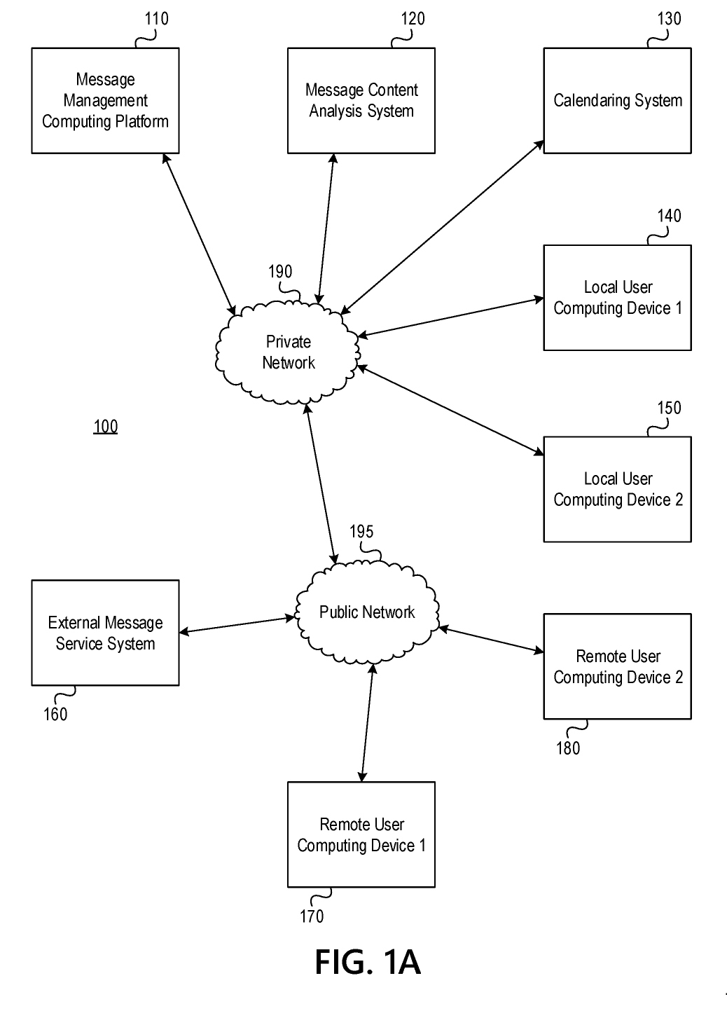

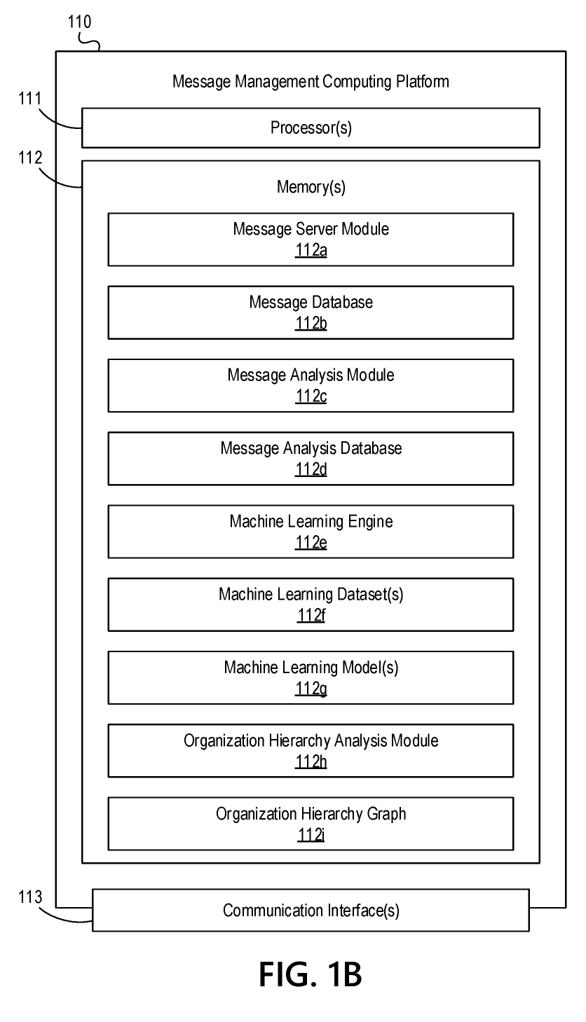

FIGS. 1A and 1B depict an illustrative computing environment for implementing and using a data processing system with a machine learning engine to provide automated message management functions in accordance with one or more example embodiments. Referring to FIG. 1A, computing environment 100 may include one or more computing devices and/or other computer systems. For example, computing environment 100 may include a message management computing platform 110, a message content analysis system 120, a scheduling system 130, a first local user computing device 140, a second local user computing device 150, an external message service system 160, a first remote user computing device 170, and a second remote user computing device 180.

Message management computing platform 110 may be configured to host and/or execute a machine learning engine to provide automated message management functions, as discussed in greater detail below. In some instances, message management computing platform 110 may receive and log messages, retrieve the logged messages, analyze the messages, determine opportunities to perform automated message management actions based on outputs of machine learning models 112g, perform the automated message management actions, validate the actions, update machine learning datasets, and update and/or retrain the machine learning models 112g. Additionally, message management computing platform 110 may host and/or execute a messaging service. For example, message management computing platform 110 may be and/or include an email server configured to host an email service and/or a chat server configured to host a chat service. In some instances, message management computing platform 110 may be and/or include a web server configured to render web-based user interfaces for accessing the messaging services (e.g., for a web-based email inbox or chat service).

Message content analysis system 120 may be configured to analyze the textual and/or other content of the messages and provide outputs to the message management computing platform 110 that may be used by the machine learning models 112g hosted and/or executed by message management computing platform 110. The message content analysis system 120 may perform sentiment analysis, topic analysis, and other analysis techniques on the text and/or other content of the messages in order to derive information useful in training the one or more machine learning models 112g and determining opportunities to perform automated message management actions.

Scheduling system 130 may be configured to store, update, and/or maintain calendar information, task information, and/or other information associated with the schedules of one or more users. For example, scheduling system 130 may be configured to provide indications of whether a user is currently busy, unable to send messages, at a meeting or other appointment, and the like. Additionally, scheduling system 130 may be configured to provide indications of available time in a user's schedule, which may be used to determine opportunities to perform automated message management actions.

Local user computing device 140 may be configured to be used by a first local user, such as a first user associated with first messaging account hosted by the message management computing platform 110. Local user computing device 150 may be configured to be used by a second local user different from the first local user, such as a second enterprise user associated with a second messaging account hosted by the message management computing platform 110.

External messaging service system 160 may be configured to host and/or otherwise provide a messaging service that can exchange messages with the messaging service hosted by message management computing platform 110. For example, external message service system 160 may provide an email server with accounts for one more remote users, by which the one or more remote users may send and/or receive email messages to local users with email accounts hosted by message management computing platform 110. In some instances, external message service system 160 may be and/or include a web server configured to render web-based user interfaces for accessing the hosted messaging services (e.g., for a web-based email inbox or a web-based chat service).

Remote user computing device 170 may be configured to be used by a first remote user, such as a first remote user associated with an account hosted by external message service system 160. Remote user computing device 180 may be configured to be used by a second remote user different from the first remote user, such as a second remote user associated with an account hosted by external message service system 160.

In one or more arrangements, message management computing platform 110, message content analysis system 120, scheduling system 130, and external message service system 160 may be any type of computing device capable of hosting and/or executing processes and services, transmitting and receiving information via a network, and providing interfaces to provide information to other such devices and receive information from other such devices. For example, message management computing platform 110, message content analysis system 120, scheduling system 130, and external message service system 160 may, in some instances, be and/or include server computers, desktop computers, laptop computers, tablet computers, smart phones, or the like that may include one or more processors, memories, communication interfaces, storage devices, and/or other components.

In one or more arrangements, local user computing device 140, local user computing device 150, remote user computing device 170, and remote user computing device 180 may be any type of computing device capable of receiving a user interface, receiving input via the user interface, and communicating the received input to one or more other computing devices. For example, local user computing device 140, local user computing device 150, remote user computing device 170, and remote user computing device 180 may, in some instances, be and/or include server computers, desktop computers, laptop computers, tablet computers, smart phones, or the like that may include one or more processors, memories, communication interfaces, storage devices, and/or other components.

As noted above, and as illustrated in greater detail below, any and/or all of message content analysis system 120, scheduling system 130, local user computing device 140, local user computing device 150, external message service system 160, remote user computing device 170, and remote user computing device 180 may, in some instances, be special-purpose computing devices configured to perform specific functions.

Computing environment 100 also may include one or more computing platforms. For example, and as noted above, computing environment 100 may include message management computing platform 110. As illustrated in greater detail below, message management computing platform 110 may include one or more computing devices configured to perform one or more of the functions described herein. For example, message management computing platform 110 may include one or more computers (e.g., laptop computers, desktop computers, servers, server blades, or the like).

Computing environment 100 also may include one or more networks, which may interconnect one or more of message management computing platform 110, message content analysis system 120, scheduling system 130, local user computing device 140, local user computing device 150, external message service system 160, remote user computing device 170, and remote user computing device 180. For example, computing environment 100 may include private network 190 and public network 195. Private network 190 and/or public network 195 may include one or more sub-networks (e.g., local area networks (LANs), wide area networks (WANs), or the like). Private network 190 may be associated with a particular organization (e.g., a corporation, financial institution, educational institution, governmental institution, or the like) and may interconnect one or more computing devices associated with the organization. For example, message management computing platform 110, message content analysis system 120, scheduling system 130, local user computing device 140, and local user computing device 150 may be associated with an organization (e.g., a financial institution), and private network 190 may be associated with and/or operated by the organization, and may include one or more networks (e.g., LANs, WANs, virtual private networks (VPNs), or the like) that interconnect message management computing platform 110, message content analysis system 120, scheduling system 130, local user computing device 140, local user computing device 150 and one or more other computing devices and/or computer systems that are used by, operated by, and/or otherwise associated with the organization. Public network 195 may connect private network 190 and/or one or more computing devices connected thereto (e.g., message management computing platform 110, message content analysis system 120, scheduling system 130, local user computing device 140, and local user computing device 150) with one or more networks and/or computing devices that are not associated with the organization. For example, external message service system 160, remote user computing device 170, and remote user computing device 180 might not be associated with an organization that operates private network 190 (e.g., because external message service system 160, remote user computing device 170, and remote user computing device 180 may be owned, operated, and/or serviced by one or more entities different from the organization that operates private network 190, such as one or more customers of the organization and/or vendors of the organization, rather than being owned and/or operated by the organization itself or an employee or affiliate of the organization), and public network 195 may include one or more networks (e.g., the internet) that connect external message service system 160, remote user computing device 170, and remote user computing device 180 to private network 190 and/or one or more computing devices connected thereto (e.g., message management computing platform 110, message content analysis system 120, scheduling system 130, local user computing device 140, and local user computing device 150).

Referring to FIG. 1B, message management computing platform 110 may include one or more processors 111, memory 112, and communication interface 113. A data bus may interconnect processor(s) 111, memory 112, and communication interface 113. Communication interface 113 may be a network interface configured to support communication between message management computing platform 110 and one or more networks (e.g., private network 190, public network 195, or the like). Memory 112 may include one or more program modules having instructions that when executed by processor(s) 111 cause message management computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of message management computing platform 110 and/or by different computing devices that may form and/or otherwise make up message management computing platform 110. For example, memory 112 may have, store, and/or include a message server module 112a, a message database 112b, a message analysis module 112c, a message analysis database 112d, a machine learning engine 112e, one or more machine learning datasets 112f, one or more machine learning models 112g, an organization hierarchy analysis module 112h, and an organization hierarchy graph 112i. Message server module 112a and message database 112b may store instructions and/or data that cause and/or enable message management computing platform 110 to provide one or more messaging services (e.g., an email service, a chat service, and the like) and/or perform other functions. Message analysis module 112c and message analysis database 112d may store instructions and/or data that cause and/or enable message management computing platform 110 to analyze messages and generate data useful for training the one or more machine learning models 112g and determining opportunities to perform automated message management actions. Machine learning engine 112e, the one or more machine learning datasets 112f, and the one or more machine learning models 112g may store instructions and/or data that cause and/or enable message management computing platform 110 to provide one or more machine learning functions and/or associated services. Organization hierarchy analysis module 112h and organization hierarchy graph 112i may store instructions and/or data that cause and/or enable message management computing platform 110 to provide one or more functions for determining a relative hierarchy of users of message management computing platform 110 with respect to other users in the same organization.

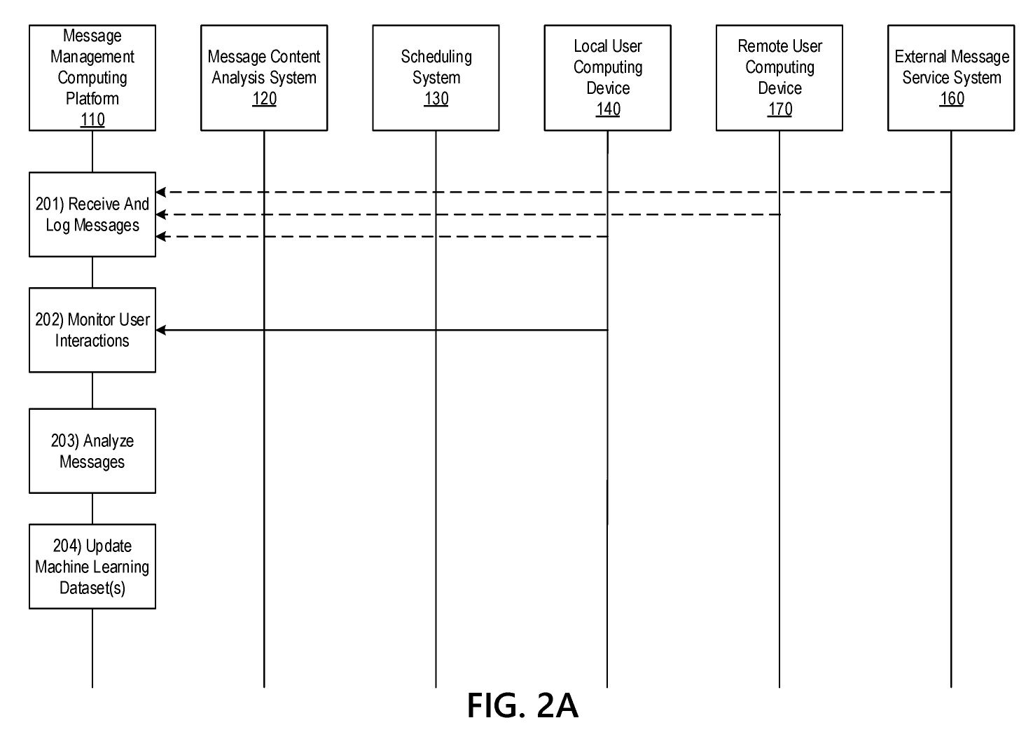

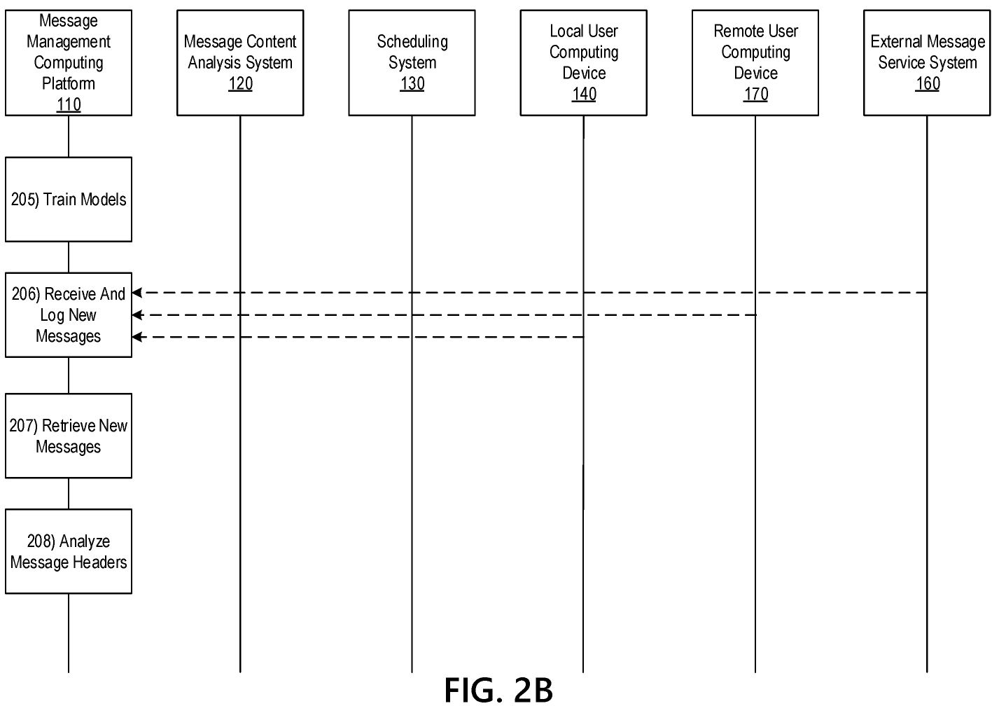

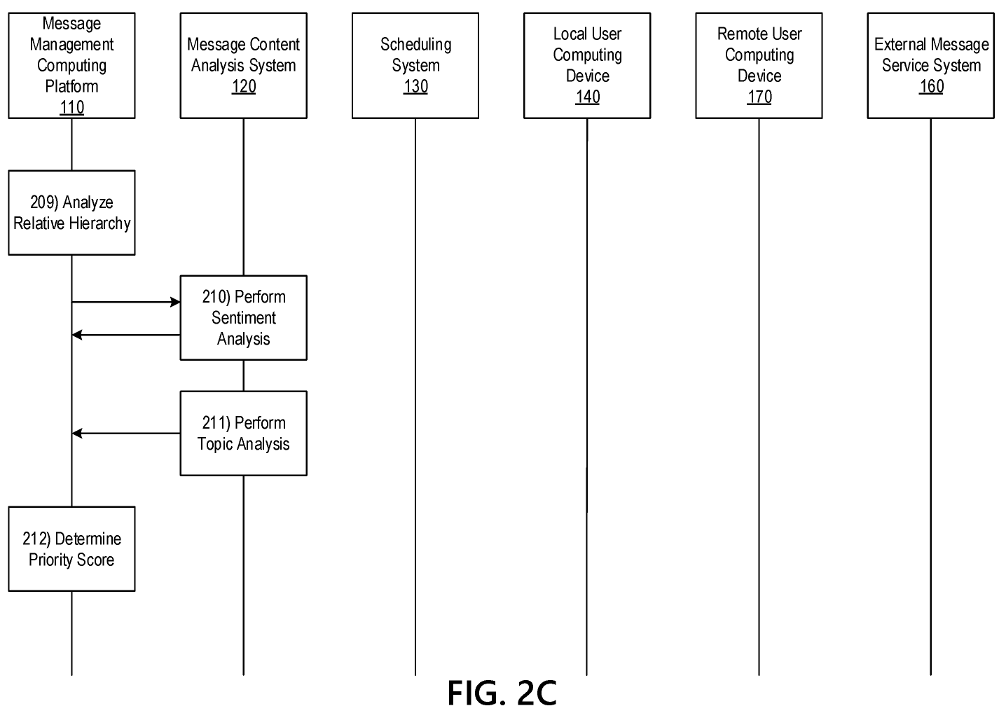

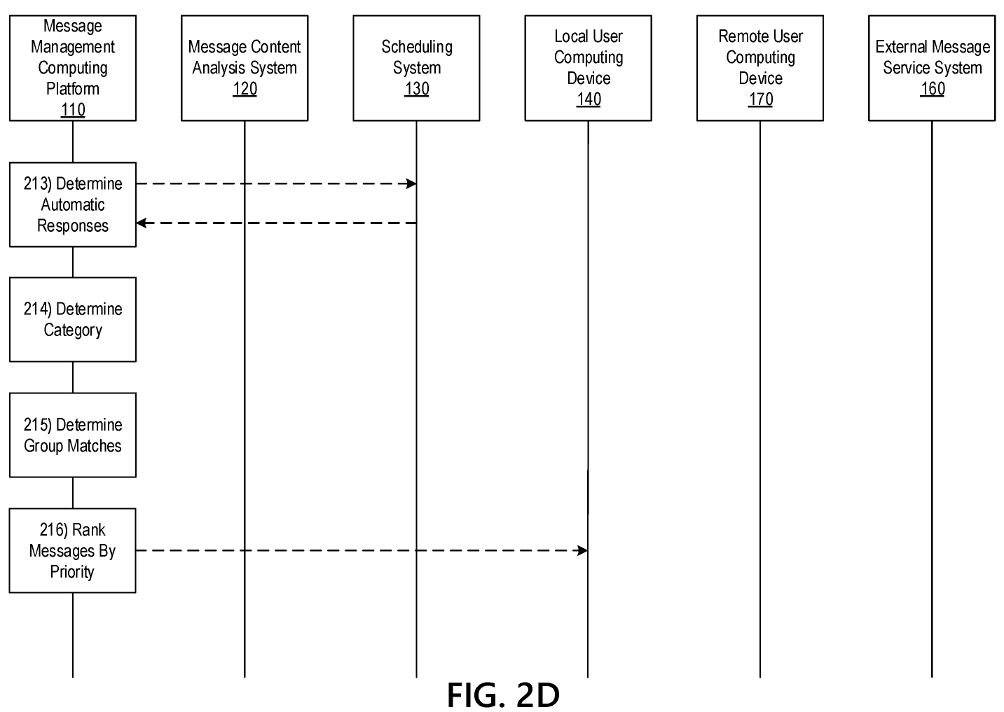

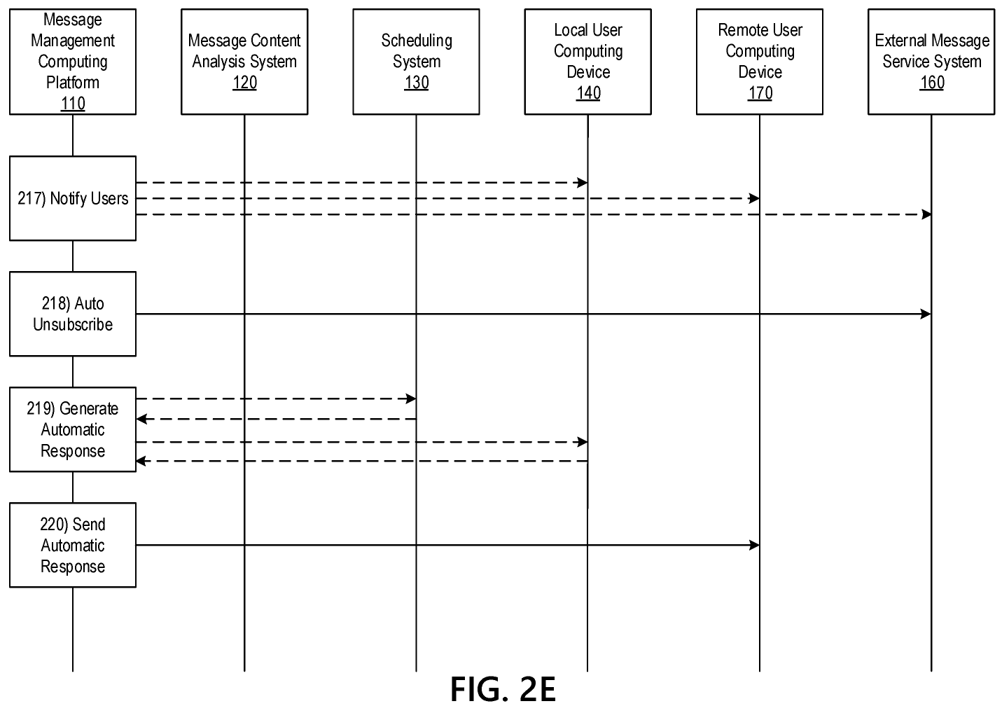

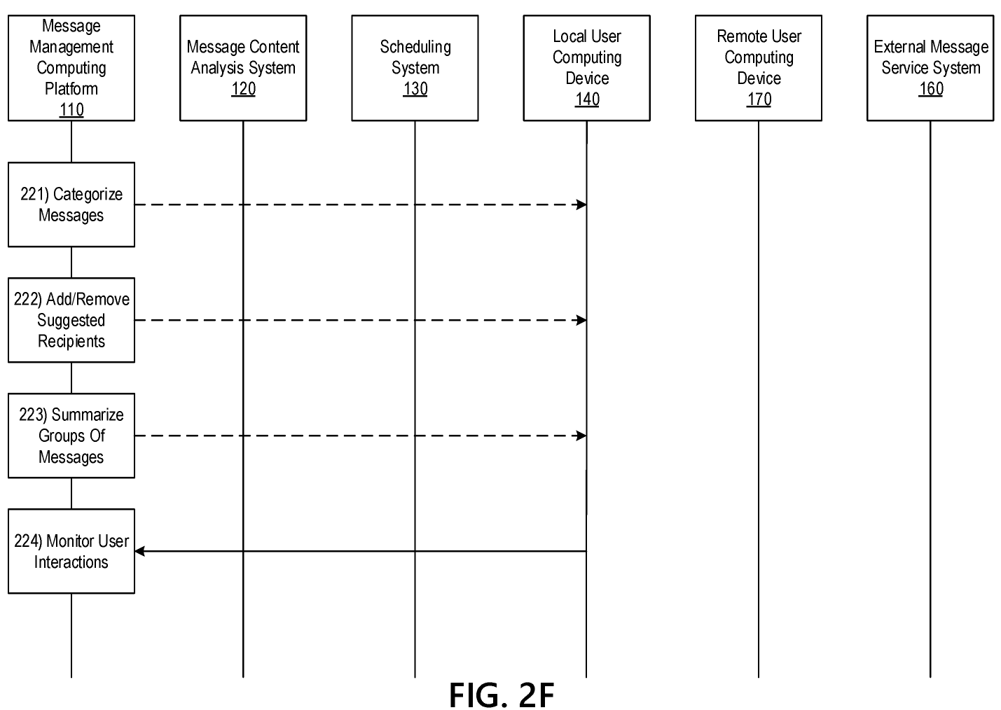

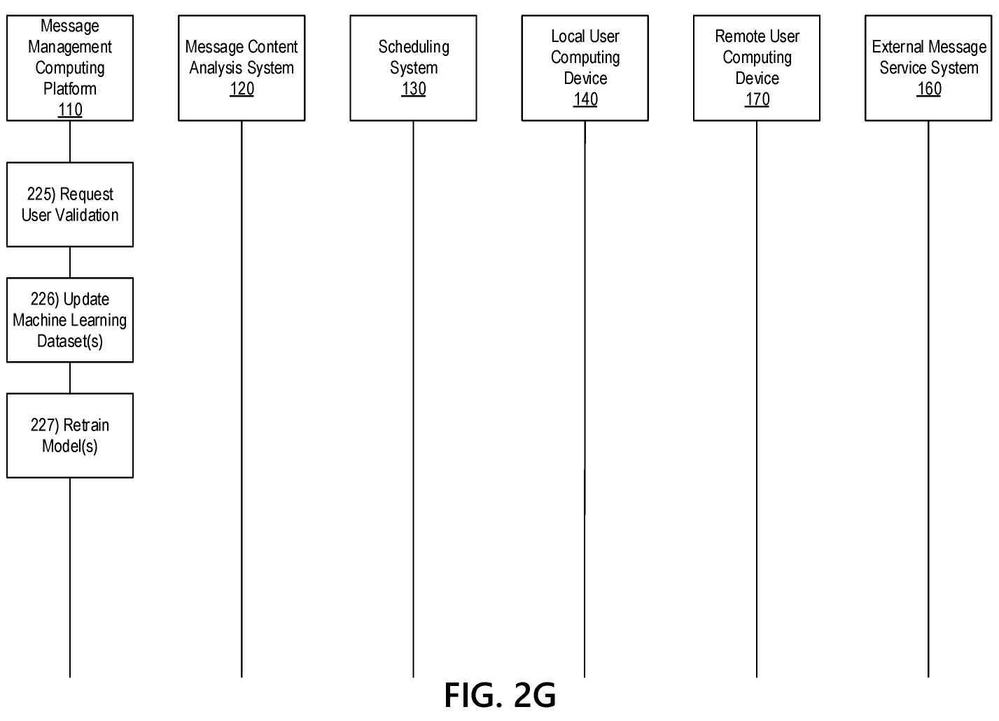

FIGS. 2A-2G depict an illustrative event sequence for implementing and using a data processing system with a machine learning engine to provide automated message management functions in accordance with one or more example embodiments. Referring to FIG. 2A, at step 201, message management computing platform 110 and/or message server module 112a receives and logs both incoming and outgoing messages from a plurality of devices. Messages received and logged by message management computing platform 110 and/or message server module 112a may include messages sent between local user computing devices (e.g., from local user computing device 140 to local user computing device 150) or messages sent between a local user computing device and a remote user computing device (e.g., from remote user computing device 170 to local user computing device 140). Messages from outside of private network 190 may be received directly from remote user computing devices or via a service hosted on an external system such as external message service system 160. For example, in the case of email messages, an email from remote user computing device 170 to local user computing device 140 may be sent by an email service hosted on external message service system 160 and received by an email service (e.g., implemented by message server module 112a) hosted by message management computing platform 110. The messages may be stored in message database 112b for provision to users with messaging accounts hosted by message management computing platform 110. In some embodiments, users (e.g., the first user of local user computing device 140) may log into message management computing platform 110 (e.g., via a web portal hosted by message server module 112a, via an API, and the like) to retrieve an inbox of messages addressed to them.

In some embodiments, the messages received and logged at step 201 are all associated with a particular user account (e.g., an account associated with a user of local user computing device 140). In other words, the process of FIGS. 2A-2G may be performed individually for some or all of a plurality of accounts associated with the messaging service in order to perform automated message management actions personalized for the user associated with the account under analysis.

At step 202, message management computing platform 110 may monitor user interactions with the messages (e.g., interactions received from a user associated with the account under analysis) so that machine learning engine 112e may train one or more machine learning models 112g to determine opportunities for performing automated message management actions based on outputs of the machine learning models 112g, as will be further described below. Message management computing platform 110 may monitor user interactions with messages including user responses to messages, user selections of messages, user categorizations of messages, and the like. Such interactions may indicate, for example, a priority that a user assigns to a message. For example, a relatively low response time (e.g., a relatively fast response time) to a particular message may indicate a high priority for that message. As another example, a user of an email service may, upon opening an inbox of unread messages, select higher priority messages before other messages. Accordingly, an order of selection of unread messages may indicate a high priority. Message management computing platform 110 may monitor and record such interactions so that machine learning engine 112e may later train, for example, a machine learning model 112g that estimates a priority of a message.

Additionally or alternatively, message management computing platform 110 may monitor user interactions including tagging or categorization of messages. For example, a user may manually tag or categorize a message as “personal,” “important”, “junk” and/or other categories. Message management computing platform 110 may monitor such categorizations so that machine learning engine 112e may train one or more models 112g to estimate a categorization of messages.

As another example, a user may frequently and/or repeatedly send a particular response, or responses sharing particular attributes, in certain contexts. For example, a user may send a response containing the keywords “busy,” “reply,” and “soon” when the user is in a meeting, out of office, or some other scheduling context and/or in response to certain senders, such as supervisor(s) of the user. Accordingly, message management computing platform 110 may monitor replies to messages sent by the user so that machine learning engine 112e may train one or more machine learning models 112g to determine an opportunity to send an automatic reply to a message.

At step 203, message management computing platform 110 and/or message analysis module 112c may perform one or more analyses on the messages received and logged at step 201 in order to generate additional data usable by machine learning engine 112e to train one or more machine learning models 112g. Such analyses may include one or more of analyzing message headers and/or other metadata associated with the message, analyzing a relative organization hierarchy between, for example, a sender of the message and a recipient of the message, performing a sentiment analysis on the message, performing a topic analysis on the message, and the like. The analyses performed by message management computing platform 110 and/or message analysis module 112c are discussed in additional detail with regard to steps 208-211. At step 204, message management computing platform 110 and/or message server module 112a may store data including the messages themselves, metadata associated with the messages, user interactions associated with the messages, the outputs of analyses performed on the messages, and/or additional data in the one or more machine learning dataset(s) 112f.

Referring to FIG. 2B, at step 205, message management computing platform 110 and/or machine learning engine 112e may generate, train, and/or update one or more machine learning models 112g. Machine learning engine 112e may train and update the one or more machine learning models 112g on an ongoing basis, on a regular schedule, at predetermined intervals, or the like, using the information stored in the one or more machine learning dataset(s) 112f. Machine learning engine 112e trains the one or more machine learning models 112g to determine, for messages outside the training data set (e.g., new messages), opportunities to perform automated message management actions. The machine learning engine 122e may use various types of machine learning techniques to generate, train, and update one or machine learning models 112g that output scores and/or classifications, including supervised machine learning techniques, unsupervised machine learning techniques, and/or statistical techniques (e.g., regression models, decision trees, and the like).

The one or more models 112g used by machine learning engine 112e to generate a priority score may be trained (e.g., by message management computing platform 110 and/or machine learning engine 112e) based on monitored user interaction data (e.g., as received in step 202) indicating various opportunities to perform automated message management actions. For example, machine learning engine 112e may use an order of selection of messages (e.g., from among available unread messages) and/or response times to messages received at step 201 as a measurement of priority of a corresponding message, and thereby train a machine learning model 112g to estimate the priority of a new message. Additionally, machine learning engine 112e may use aggregated user interaction data (e.g., in conjunction with monitored interactions received at step 202) to train a personalized machine learning model 112g based on both user-specific and aggregated data.

Accordingly, after training the one or more machine learning models 112g, message management computing platform 110 and/or machine learning engine 112e may be able to determine one or more opportunities to perform automated message management actions on, for example, new messages in response to receipt of the new messages. In some embodiments, message management computing platform 110 and/or machine learning engine 112e may be configured to determine one or more opportunities to perform automated message management actions, such actions including ranking messages, notifying users about unresponded messages, automatically un-subscribing from mailing lists associated with messages, generating and/or sending automatic responses to messages, categorizing messages, adding or removing suggested recipients for responses to messages, summarizing groups of messages, and the like.

Message management computing platform 110 and/or machine learning engine 112e may, in some embodiments, train separate models 112g for determining different types of opportunities to perform automated message management actions. For example, machine learning engine 112e may train one machine learning model 112g to estimate a priority of a message, and another machine learning model 112g to determine an opportunity to send an automatic response to a message. In some embodiments, machine learning engine 112e may train multiple models 112g for each type of opportunity to perform automated message management actions. For example, machine learning engine 112e may train multiple models 112g to estimate a priority of a message. In some embodiments, machine learning engine 112e may later select one of the multiple models 112g as the best machine learning model 112g (e.g., based on validations steps 224-225, further discussed below) and use the best machine learning model 112g in future executions of the process of FIGS. 2A-2G.

In some embodiments, message management computing platform 110 and/or machine learning engine 112e may train different models 112g for different users associated with the message service. In other words, machine learning engine 112e may provide personalized automated message management actions based on training data associated with a particular user. In some embodiments, machine learning engine 112e may train models 112g for groups of users associated with the message service (e.g., a team within an organization, an entire organization, and the like) based on training data associated with the groups of users. Accordingly, in some embodiments, the messages received and logged at step 201 and analyzed at step 203, and the user interactions monitored at step 202, may be associated with a particular account under analysis (e.g., when message management computing platform 110 is determining opportunities to perform automated message management actions using one or more personalized machine learning models 112g). Additionally or alternatively, the messages received and logged at step 201 and analyzed at step 203, and the user interactions monitored at step 202, may be associated with multiple accounts under analysis.

At step 206, message management computing platform 110 and/or message server module 112a receives and logs new messages (e.g., messages received after training the one or more machine learning models 112g). Similarly as for step 201, the new messages received and logged by message management computing platform 110 and/or message server module 112a may include messages sent between local user computing devices (e.g., from local user computing device 140 to local user computing device 150) or messages sent between a local user computing device and a remote user computing device (e.g., from remote user computing device 170 to local user computing device 140). Messages from outside of private network 190 may be received directly from remote user computing devices or via a service hosted on an external system such as external message service system 160. For example, in the case of email messages, an email from remote user computing device 170 to local user computing device 140 may be sent by an email service hosted on external message service system 160 and received by an email service (e.g., implemented by message server module 112a) hosted by message management computing platform 110. The new messages may be stored in message database 112b for provision to users with messaging accounts hosted by message management computing platform 110.

At step 207, message management computing platform 110 and/or message analysis module 112c retrieves the new messages (e.g., from message database 112b) for analysis before determining one or more opportunities to perform automated message management actions. The message management computing platform 110 may retrieve the messages for analysis in batches.

For example, message management computing platform 110 may retrieve all of the messages pertaining to a particular user account, all of the messages sent/received by a user account in a certain time frame (e.g., the current day), a certain number of messages (e.g., the most recent 200 messages associated with a user), and/or all of the messages sent/received since the last analysis. In some embodiments, message management computing platform 110 may avoid retrieving certain messages that may not be suitable for analysis. For example, in the case of email, message management computing platform 110 may use sender blacklists/whitelists, spam indicators, and the like to avoid retrieving emails not suitable for performing automated message management actions. The message management computing platform 110 thus retrieves a plurality of messages for further analysis.

At step 208, message management computing platform 110 and/or message analysis module 112c may analyze messages based on headers and/or other metadata pertaining to the message. The analysis of the metadata may comprise determining identities of senders/receivers of the message, determining the time between a message that was received and a message that was sent in response (e.g., the response time), determining whether messages are related (e.g., part of an email thread or chat group), and the like. For example, in the case of email, message management computing platform 110 may analyze the email addresses contained in the “from:”, “to:”, “cc:” and/or “bcc:” fields of the header and match the email addresses to identities contained in the message analysis database 112d. Message management computing platform 110 may further mark messages as either “responded” or “unresponded” based on whether a message received a response or not.

Referring to FIG. 2C, at step 205, message management computing platform 110, message analysis module 112c, and/or organization hierarchy analysis module 112h may analyze and generate a score describing the relative hierarchy between a user associated with the message and the various other senders/recipients of the message. For example, in the case of email, message management computing platform 110 may determine hierarchy scores for the sender of an email sent to a user's account, other users that received the same email, other users that were included on the same email (e.g., in the “cc:” field), and the like.

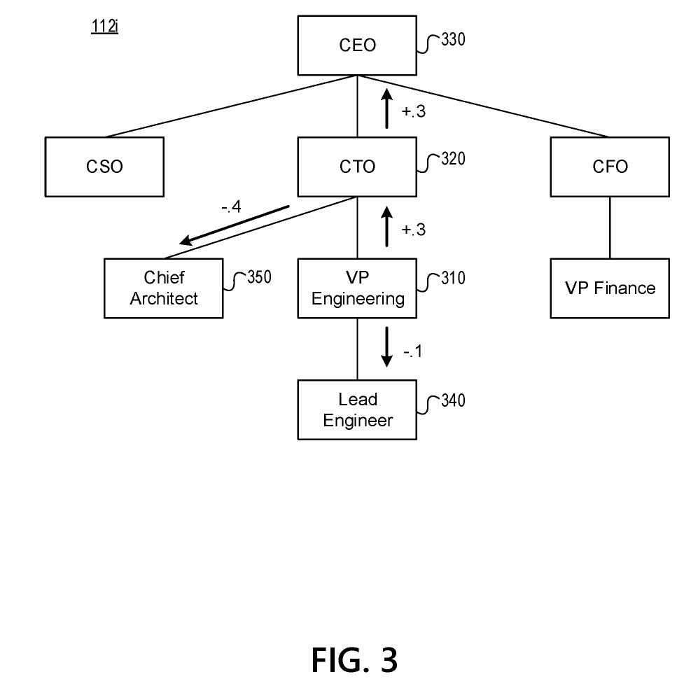

The message management computing platform 110, message analysis module 112c, and/or organization hierarchy analysis module 112h may access an organization hierarchy graph 112i and determine the relative hierarchy score for message senders and/or recipients based on the distance and direction between the user associated with the account under analysis and other senders/recipients on the organization hierarchy graph 112i. Referring to FIG. 3, an example organization hierarchy graph 112i for a corporation is depicted. In the illustrated example, messages associated with user 310 are being analyzed. For example, message management computing platform 110 may analyze a message received by user 310 and sent by user 320.

Because user 320 is higher in the organization hierarchy than user 310, the relative hierarchy score for the sender (user 320) may be relatively high (e.g., a positive number such as +0.3, as illustrated). In some examples, the relative hierarchy score may increase or decrease for each level of hierarchy up or down the organization hierarchy graph 112i. For example, if user 330 had sent the message to user 310, the relatively hierarchy score for the sender would be higher still (e.g., +0.6, calculated by adding +0.3 corresponding to the hop from user 310 to user 320 to +0.3 corresponding to the hop from user 320 to user 330). In contrast, if user 340 had sent the message to user 310, the relative hierarchy score of the sender would be lower (e.g., a negative number, such as −0.1 as illustrated). In some examples, the relative hierarchy score may increase by relatively more (and/or decrease by relatively less) for direct reporting chains as compared to indirect reporting chains. For example, a relative hierarchy score for a direct report of user 310 (such as user 340) may be the same (or higher) than a relative hierarchy score for a user that is organizationally higher in another line of reporting (such as user 350). In the illustrated example, user 350 has the same relative hierarchy score, relative to user 310, as user 340, even though user 340 is lower in the hierarchy in an absolute sense. In other words, the organization hierarchy graph 112i may prioritize lines of reporting by increasing the relative hierarchy scores of a user's supervisors and/or direct reports.

Referring back to FIG. 2C, as described above, at step 209, message management computing platform 110 may calculate individual hierarchy scores for senders and/or recipients of the message other than the user associated with the account under analysis. Additionally or alternatively, message management computing platform 110 may generate an overall hierarchy score based on the individual relative hierarchy scores. In some embodiments, message management computing platform 110 may generate such an overall hierarchy score by taking an average of the individual relative hierarchy scores. In some embodiments, the average may be a weighted average that prioritizes some types of senders/recipients. For example, in the case of email, a sender could be given a higher weight than a user included in a “cc:” field such that the relative hierarchy score of the sender may affect the overall hierarchy score more than the relative hierarchy score of the user included in the “cc:” field.

At step 210, message management computing platform may send the messages to message content analysis system 120, which may perform sentiment analysis on the textual and/or other content (e.g., images, hypertext, links, emojis, and the like) of the messages.

Message content analysis system 120 may use one or more of natural language processing, textual analysis, and/or computational linguistics techniques to determine a sentiment of the messages. In some embodiments, message content analysis system 120 may indicate a polarity of the message (e.g., a positive, negative, or neutral tone). Additionally or alternatively, message content analysis system 120 may indicate one or more moods associated with the message (e.g., angry, happy, neutral, and the like). Message content analysis system 120 may assign the one or more indicated sentiments to the corresponding message and send the indicated sentiments back to message management computing platform 110, as illustrated.

At step 211, message content analysis system 120 may perform topic analysis on the messages. Message content analysis system 120 may find key words and/or phrases (herein “keywords”) in a message and extract the keywords from the message in order to determine one or more topics associated with the message. In some embodiments, message content analysis system 120 may find the keywords using statistical methods, such as term frequency-inverse document frequency (TF*IDF) and the like. Additionally or alternatively, message content analysis system 120 may use supervised or unsupervised machine learning methods to find the keywords. In the case of email, message content analysis system 120 may be more likely to select keywords appearing in a subject line of the email.

Message content analysis system 120, in addition to or as an alternative to finding one or more keywords in the text of the message, at step 211, may analyze the content of a message to determine one or more particular pre-defined topics matching the content of the message. For example, message content analysis system 120 may use statistical and/or machine learning techniques to match the content of the message to one or more of such pre-defined topics. After performing the topic analysis, message content analysis system 120 may assign the one or more indicated keywords and/or pre-defined topics to the corresponding message and send the indicated keywords and/or pre-defined topics back to message management computing platform 110, as illustrated.

After executing and/or receiving outputs of various message analysis steps (e.g., steps 208-211), message management computing platform 110 and/or machine learning engine 112e may determine one or more opportunities to perform automated message management actions based, at least in part, on various features including the outputs of the analysis steps 208-211 and/or other data pertaining to the message (e.g., the content of the message, metadata associated with message, and the like). In some embodiments, message management computing platform 110 and/or machine learning engine 112e may use one or more machine learning models 112g to output scores and/or classifications that message management computing platform 110 may use to determine whether message management computing platform 110 will perform one or more automated message management actions. Such scores and/or classifications may include at least a message priority score, an automatic response classification, a category classification, and/or a group matching classification.

At step 212, machine learning engine 112e and/or message management computing platform 110 may generate a priority score for some or all of the messages in the plurality of messages retrieved in step 202. The priority score may indicate an importance of the message to the user associated with the account under analysis. A machine learning model 112g trained to indicate a message priority may output a discrete priority score (e.g., “high,” “medium,” “low,” and the like) or a continuous priority score (e.g., a number within a range). In some examples, the outputs of steps 208-211 may be used as input features that tend to indicate a higher or lower priority score in combination with other input features. For example, the organization hierarchy scores generated in step 209 may tend to indicate a higher priority score in some contexts but not in others (e.g., an email from a sender with a high organization hierarchy score directly to the user may tend to indicate a high priority score, whereas an email from a sender with a high organization hierarchy score addressed to an organization-wide mailing list may tend to indicate a low priority score). In some instances, certain sentiments, topics, keywords, and the like may tend to indicate a higher or lower priority score in conjunction with other features. In some instances, the identities of senders/receivers of the message (including, for example, whether the identities are known, whether they are part of the same organization, whether they are senders, receivers, included in “cc:” fields, and the like) may tend to indicate a higher or lower priority score. For example, a user may frequently reply quickly to messages from their spouse, their boss, and their direct report. Accordingly, the machine learning model 112g for estimating a priority score, as trained by machine learning engine 112e, may associate such messages with high priority scores.

Referring to FIG. 2D, at step 213, message management computing platform 110 and/or machine learning engine 112e may determine an automatic response classification for some or all of the messages retrieved at step 207 (e.g., for only the retrieved messages tagged as “unresponded”). In some embodiments, machine learning engine 112e may use different machine learning models 112g for generating the priority score, the automatic response classification, and other scores and/or classifications. In some embodiments, the output of one machine learning model 112g may be used as input for another machine learning model 112g. For example, machine learning engine 112e may accept, as input to the machine learning model 112g for generating an automatic response classification, the priority score outputted by another machine learning model 112g. Thus, for example, machine learning engine 112e may be more likely to recommend sending automatic responses to higher priority messages.

As illustrated, message management computing platform 110 and/or machine learning engine 112e may optionally access, as additional input features to the machine learning model 112g for generating an automatic response classification, scheduling information from scheduling system 130. Scheduling system 130 may maintain information indicating a user's schedule, such as a calendar. Such scheduling information may include meetings and appointments on a user's calendar, whether the user has an away status set, whether the user is on vacation, whether the current time is within a user's working hours, what times a user has available to schedule meetings or appointments, and the like. Message management computing platform 110 may request and receive such information as illustrated.

Machine learning engine 112e may classify a message as fitting one or more types of automatic response classifications. In some embodiments, machine learning engine 112e may output, for each message it analyzes, discrete value(s) indicating one or more classifications and optional confidence levels for the one or more classifications. For example, machine learning engine 112e may classify a message as an opportunity to automatically generate an “away message” response, a “please follow up later” response, and/or a “set up a meeting” response. Continuing the example, certain combinations of input features, such as scheduling information indicating the user is away, a high priority score, a certain identity of the sender, and/or the user as sole recipient (e.g., no other users in the “to:” or “cc:” fields in the case of an email) may tend to indicate an “away message” response classification with a high confidence (e.g., a response indicating the user is away but will reply soon). Similarly, certain combinations of input features, such as scheduling information indicating the user is busy and/or a low priority score, may tend to indicate a “please follow up later” response classification (e.g., a response requesting the sender to try messaging again later when the user is less busy). As another example, certain combinations of input features, such as keywords in the message including “meeting,” “availability,” and/or “schedule” may tend to indicate a “set up a meeting” response classification (e.g., a response indicating the user's availability and a request to select a time for a meeting).

At step 214, machine learning engine 112e may determine a category classification for some or all of the messages retrieved at step 207. In some embodiments, machine learning engine 112e may classify the messages using a machine learning model 112g trained to classify the messages into one or more discrete categorizations, such as “personal,” “important,” “junk,” and the like. In some embodiments, machine learning engine 112e may use, as inputs to the machine learning model 112g for classifying the messages into categorizations, the content of the messages, metadata associated with the messages, the outputs of analysis steps 208-211, the priority score generated in step 212, and/or information derived therefrom. In some embodiments, the one or more categories may be categories generated by the user, and the data used for training the machine learning model 112g may include manual user categorizations received from the user associated with the account under analysis as monitored in step 202. Additionally or alternatively, the one or more categories may include categories generated by other users and/or pre-defined categories, and the data used for training the machine learning model 112g may include manual user categorizations received from other users as monitored in step 202, or from external data sets. In some embodiments, machine learning engine 112e may use unsupervised machine learning techniques (e.g., clustering algorithms) to find potential new categories. Such new potential categories may be suggested to a user, as further discussed below.

At step 215, message management computing platform 110 and/or machine learning engine 112e may compare messages to other messages and/or groups of messages to determine similarities between the message and the other messages and/or groups of messages. For example, in the case of email, the email may be compared to other emails to determine a similarity and group the emails into a single thread. In some embodiments, message management computing platform 110 and/or machine learning engine 112e may compare the message itself, metadata associated with the message, the outputs of analysis steps 208-211, the priority score generated in step 212, and/or information derived therefrom to comparable information for the other messages or groups of messages in order to determine a similarity. For example, messages sharing a certain number of keywords, a topic, a sentiment, senders/receivers, and/or other information may be designated as similar messages. Additionally or alternatively, the similarity between the message and the other message(s) may be determined using the clusters optionally generated in step 214. For example, messages appearing in the same clusters may be indicated as similar messages. Based on message management computing platform 110 and/or machine learning engine 112e indicating message similarity, message management computing platform 110 may group the messages together (e.g., into threads, topics, categorizations, and the like).

At steps 216-223, message management computing platform 110 may perform one or more automated message management actions for the messages retrieved in step 207 in response to the determinations of opportunities to perform automated message management actions generated in steps 212-215 and/or other information. At step 216, message management computing platform 110 may rank and/or otherwise reorganize the messages by the priority score generated in step 212. For example, message management computing platform 110 may reorganize an email inbox from a chronological order into an order listing higher priority messages before lower priority messages. After reorganizing the messages, message management computing platform 110 may optionally send a notification and/or push an update to a device associated with the account under analysis (e.g., to local user computing device 140, as illustrated). Additionally or alternatively, local user computing device may later request an update, and message management computing platform 110 may send the messages in the updated order. For example, a user of an email account may log into the email service and view an email inbox containing the messages in an order according to the priority scores of the messages.

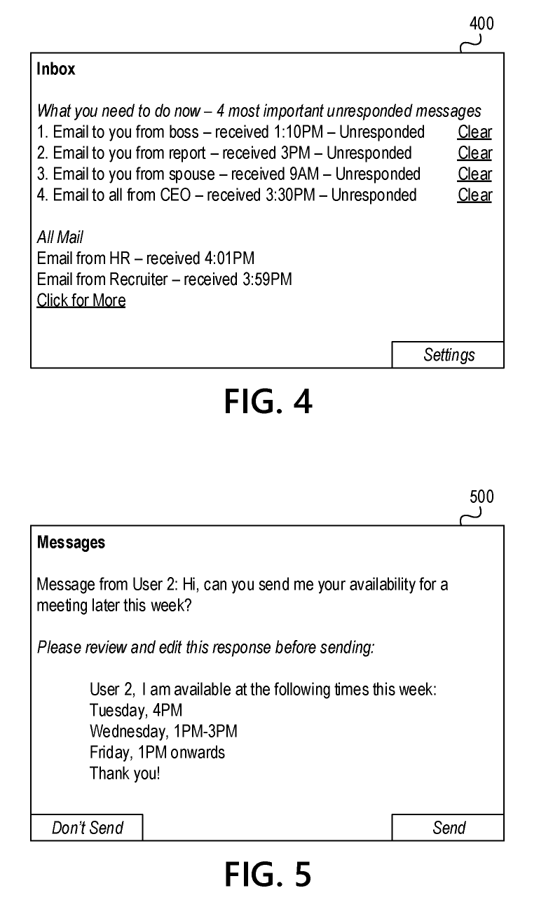

In some embodiments, the messages may be grouped or batched for display to the user associated with the account under analysis. For example, as illustrated at FIG. 4, message management computing platform 110 and/or message server module 112a may generate a user interface 400 containing a list of the highest priority messages. In some embodiments, message management computing platform 110 and/or message server module 112a may select a certain number of the highest priority messages having certain characteristics (e.g., four unresponded messages) and/or all messages above a threshold priority score having the characteristics for presentation in a particular region of user interface 400. In the illustrated embodiment, message management computing platform 110 and/or message server module 112a may provide a “clear” or similar option to remove the chosen message from the particular region of user interface 400 (e.g., if the user does not wish to take any action on the particular message). In response to the user selecting such an option, message management computing platform 110 and/or message server module 112a may optionally replace the removed message with the next highest priority message having the characteristics associated with the particular region for displaying high priority messages. message management computing platform 110 and/or message server module 112a may further configure the user interface 400 based on user-specific and/or organization-specific account settings, which may be stored in message database 112b. For example, the settings may indicate how many messages to display in the particular region for displaying high priority messages, characteristics of messages that will be displayed in the particular region for displaying high priority messages (e.g., only unread and/or un-responded messages, only messages belonging to a certain category), and the like.

Referring to FIG. 2E, at step 217, message management computing platform 110 and/or message server module 112a may notify one or more users about an unresponded high priority message. For example, if a user does not respond to a message having a high priority for above a threshold amount of time, message management computing platform 110 and/or message server module 112a may send a notification to a device associated with the user (e.g., local user computing device 140). In some embodiments, the notification may be sent by an alternate communication mechanism, such as a text message or phone call notifying a user about an unresponded email. In some embodiments, the threshold amount of time may be inversely proportional to the priority score of the message, such that message management computing platform 110 and/or message server module 112a may generate and send notifications regarding unresponded higher priority messages before generating and sending notifications regarding unresponded lower priority messages. In some embodiments, other users may be notified in addition to or as alternatives to the user associated with the account. For example, message management computing platform 110 and/or message server module 112a may optionally send notifications to one or more other users similar to the user associated with the account (e.g., users in similar roles, or other users on the same team) if the user associated with the account does not reply to the message beyond a threshold amount of time. Such other users may be associated with other local user computing devices (e.g., local user computing device 150) and/or remote user computing devices (e.g., remote user computing device 170), and the notifications may be sent directly to the user computing devices and/or via an external system (e.g., external messaging service system 160). In some embodiments, the other users that receive notifications may be selected from other users that were recipients of the message (e.g., users that were included in a “cc:” field on an email) and/or based on user preferences associated with the user account.

At step 218, message management computing platform 110 and/or message server module 112a may attempt to automatically un-subscribe from a mailing list associated with a message having a low priority score. For example, message management computing platform 110 may, for messages with a priority score below a certain threshold, scan the message for a link associated with and/or nearby a keyword such as “unsubscribe,” access a URL associated with the link, receive a web page, parse the received web page to find an option to un-subscribe from the mailing list, and transmit an indication of a selection of such an option. message management computing platform 110 and/or message server module 112a may thus access and communicate with a web server running on an external system (e.g., a web server running on external message service system 160, which may have generated the low priority message, as illustrated).

At step 219, message management computing platform 110 and/or message server module 112a may generate automatic responses to messages based on the automatic response categorizations determined in step 213. In some embodiments, message management computing platform 110 and/or message server module 112a may generate automatic responses when a confidence associated with the automatic response categorization is above a certain threshold.

Automatic responses may include pre-configured content and/or content taken from previous responses sent by a user. In some embodiments, message management computing platform 110 and/or message service module may access a scheduling system 130 to retrieve availability information for generating an automatic response that includes such information. In some embodiments, message management computing platform 110 and/or message server module 112a may transmit an automatic response to a user for review before sending the automatic response.

As illustrated at FIG. 5, message management computing platform 110 and/or message server module 112a may generate a user interface 500 for confirming an automatic response by a user before sending (or canceling) the automatic response. As illustrated by user interface 500, the automatic response may include scheduling information (e.g., retrieved from scheduling system 130) in response to a categorization of the message as an opportunity to send a “schedule a meeting” automatic response. In this example, the generated automatic response may be provided for user review so that a user may edit the automatic response before sending the automatic response. For example, the user may add or delete times and/or otherwise change the content of the message. In some embodiments, message management computing platform 110 and/or message server module 112a may request availability information from scheduling system 130 based on one or more keywords appearing in the message. For example, based on detecting the keyword “this week” in the illustrated message, message management computing platform 110 and/or message server module 112a may request availability corresponding to a current week from scheduling system 130 before generating the automatic response. After reviewing and/or editing the automatically-generated response, the user may select an option to send or cancel (e.g., “don't send”) the response.

Referring back to FIG. 2E, at step 220, message management computing platform 110 and/or message server module 112a may send the automatic response. In some instances, the response may be sent automatically. In some instances, the response may be sent by the user after review. In some embodiments, the decision of whether to send the message automatically or after review may be based on a confidence level associated with the automatic response classification. For example, for a confidence level above a certain threshold, the automatic response may be automatically transmitted at step 220. Additionally or alternatively, in some embodiments, the decision of whether to send the message automatically or after review may be based on a context of the user, such as a context obtained from scheduling system 130 (e.g., the message may be sent automatically if the user is away, in a meeting, on vacation, outside of working hours, or the like).

Referring now to FIG. 2F, at step 221, message management computing platform 110 and/or message server module 112a may categorize and/or re-categorize messages into one or more categories indicated by the category classifications determined at step 214. In some embodiments, message management computing platform 110 and/or message server module 112a may categorize and/or re-categorize the message based on a confidence level associated with the category classification. In some embodiments, message management computing platform 110 and/or message server module 112a may move the messages into a category folder or thread, or otherwise organize the messages based on categories. In some embodiments, based on machine learning engine 112e detecting a potential new category (e.g., using clustering algorithms), message management computing platform 110 and/or message server module 112a may ask the user for approval to create the new category and/or categorize messages in it.

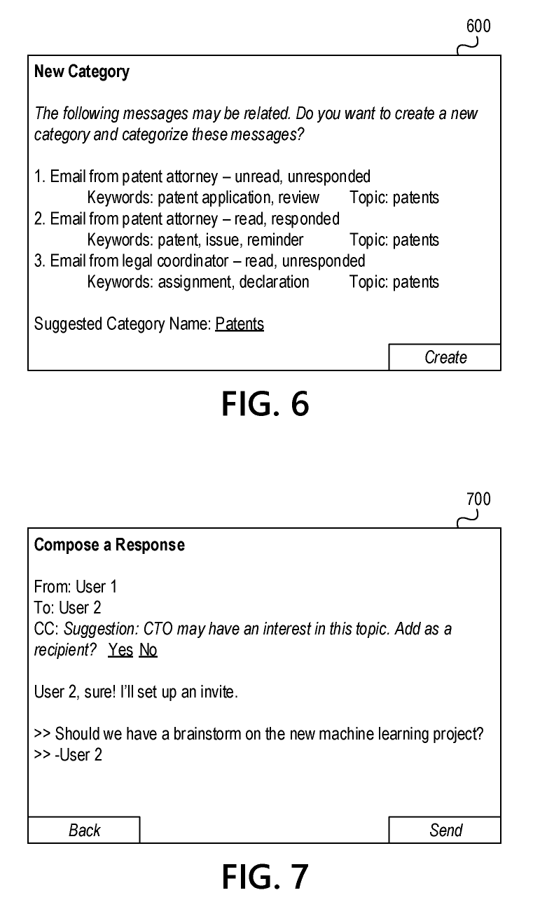

FIG. 6 illustrates a user interface 600, generated by message management computing platform 110 and/or message server module 112a, for suggesting a new category to a user. As illustrated, the messages may be related by certain characteristics (e.g., senders and/or recipients, keywords, topics, and the like) such that machine learning engine 112e (using, e.g., unsupervised learning techniques) detects that they form a cluster at step 214. Message management computing platform 110 and/or message server module 112a may then prompt the user for input indicating whether the user wishes to create a new category and/or categorize/re-categorize the indicated messages. In some embodiments, message management computing platform 110 and/or message server module 112a may suggest a name for the category. In some embodiments, the suggested name may include or be based on an attribute or characteristic common to some or all of the messages (e.g., the common topic of “patents,” as illustrated). In some embodiments, the user may edit the suggested name via user interface 600 before creating the new category.

At step 222, message management computing platform 110 and/or message server module 112a may suggest recipients to add/remove to a reply to the message based on categorizations generated at step 214 and/or group matches generated at step 215. In some embodiments, when a user is composing a reply to a message, other users included in similar messages may be suggested as potential recipients to be added. Referring to FIG. 7, message management computing platform 110 and/or message service module may generate a user interface for suggesting an additional recipient according to step 222. As illustrated, a user (“User 1”) is composing a reply to a message from another user (“User 2”). Due to certain keywords and/or topics (e.g., “machine learning”) appearing in the message from the other user, message management computing platform 110 and/or message service module may generate a suggestion to include a recipient (e.g., “CTO”) who is a sender or recipient in other similar messages (e.g., other messages about “machine learning”). The user composing the response may select options for including the suggested user or not, as illustrated.

In the example of FIG. 7, message similarity may have been determined based on common keywords and/or topics (e.g., “machine learning”). Accordingly, the suggestion may indicate that the suggested user was a sender and/or recipient in other messages sharing those keywords and/or topics. However, in other examples, message similarity may be determined based on keywords, topics, and/or other factors, as discussed for steps 214 and 215. Accordingly, the suggestions generated by message management computing platform 110 and/or message server module 112a may indicate any common context in which the suggested user was previously included as a recipient. Additionally or alternatively, message management computing platform 110 and/or message server module 112a may suggest users to remove from a recipient list, based on those users not appearing as senders/recipients in similar messages.

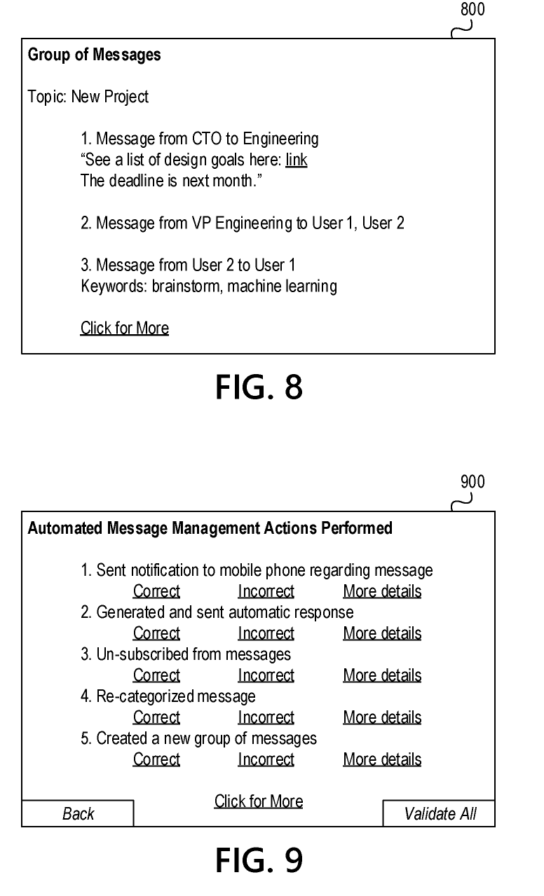

At step 223, based on the categorizations determined at step 214 and/or the group matches determined at step 215, message management computing platform 110 and/or message server module 112a may generate a summary of groups of messages (e.g., threads, categories, or other messages detected as similar). Referring to FIG. 8, message management computing platform 110 and/or message server module 112a may generate a user interface displaying one or more messages of the group in summary form. In some embodiments, summaries of a message may contain information such as quotes, snippets, or the entire contents of the message, metadata about the message, keywords associated with and/or extracted from the message, and/or the like. In some embodiments, messages having a higher priority value may be displayed with more information. Accordingly, for example, a summary for a first message of the group associated with a high priority score may include content (e.g., a quotation) taken from the message together with metadata describing the message. Moreover, a summary for a second message of the group associated with a low priority score may include only metadata describing the message. Finally, a summary for a third message of the group may include metadata describing the message and keywords describing the message. In some embodiments, the user interface for displaying summaries of groups of messages may display messages in chronological order, ordered by priority, and/or by thread (e.g., a message and its response may be grouped together).

In some embodiments, the user interface may include an indication of an attribute common to the group (e.g., all of the messages of the group of user interface 800 may be associated with a topic of “new project”), as determined at steps 214 and/or 215.

At step 224, message management computing platform 110 and/or message server module 112a may continue to monitor user interactions. Similarly as for step 202, message management computing platform 110 may monitor user interactions with messages including user responses to messages, user selections of messages, user categorizations of messages, and the like. Message management computing platform 110 may further monitor user interactions with messages associated with one or more automated message management actions performed by message management computing platform 110 in order to validate the one or more automated message management actions. In some instances, message management computing platform 110 may monitor a response time and/or an order of selection for messages that were ranked and/or batched according to priority in step 216 in order to determine if the priority score was accurate. In some instances, message management computing platform 110 may monitor whether a user responds to a notification sent at step 217 to determine if the notification was useful or not. In some instances, message management computing platform 110 may monitor whether a user re-subscribes to a mailing list for which message management computing platform 110 un-subscribed at step 218. In some instances, message management computing platform 110 may determine whether a user cancels or significantly edits an automatic response generated in step 219. In some instances, message management computing platform 110 may monitor whether a user re-categorizes messages that were automatically categorized at step 221. In some instances, message management computing platform 110 may monitor whether a user accepts suggestions to add/remove one or more recipients according to step 222. In some instances, message management computing platform 110 may monitor whether a user moves messages out of a group determined in step 223. Accordingly, message management computing platform 110 may monitor how a user interacts with the automated message management actions in order to validate the automatic actions.

At step 225, message management computing platform 110 and/or message server module 112a may request explicit validation of one or more automated message management actions from a user. For example, message management computing platform 110 may generate a summary of the automated message management actions it performed and ask a user for feedback. Referring to FIG. 9, message management computing platform 110 and/or message server module 112a may generate a user interface 900 listing summaries of automated message management actions performed, and request feedback on the automated message management actions performed. A user may be provided options to indicate agreement with the action and/or disagreement with the action in order to validate the automatic action or not.

At step 226, message management computing platform 110 and/or message server module 112a may update the machine learning dataset(s) 112f with the new messages (e.g., the messages received at step 206), the analyses of the messages (e.g., as performed at steps 208-211), user interactions with the messages (e.g., as monitored at step 224), information describing the automated message management actions performed and any validations thereof (e.g., as generated by steps 212-225), and/or other information useful for the machine learning engine 112e to retrain and/or update the one or more machine learning models 112g.

At step 227, message management computing platform 110 and/or machine learning engine 112e may update and/or retrain the one or more machine learning models 112g based on the updated data stored in the machine learning datasets after step 226. Message management computing platform 110 and/or machine learning engine 112e may, for example, tune one or more parameters or properties of the one or more models 112g to more closely match the validated actions. In some embodiments, message management computing platform 110 and/or machine learning engine 112e may select from among multiple models 112g trained to determine an opportunity for a particular action, in order to select a machine learning model 112g that best predicts the validated actions.

In some embodiments, some of steps 201-227 may be performed out of order or in parallel. For example, analysis steps 208-211 could be performed in a different order or in parallel, opportunity determination steps 212-215 could in some embodiments be performed in a different order or in parallel, automated message management action steps 216-223 could be performed in a different order or in parallel, and/or validation steps 224-225 could be performed in a different order or in parallel, among other variations.

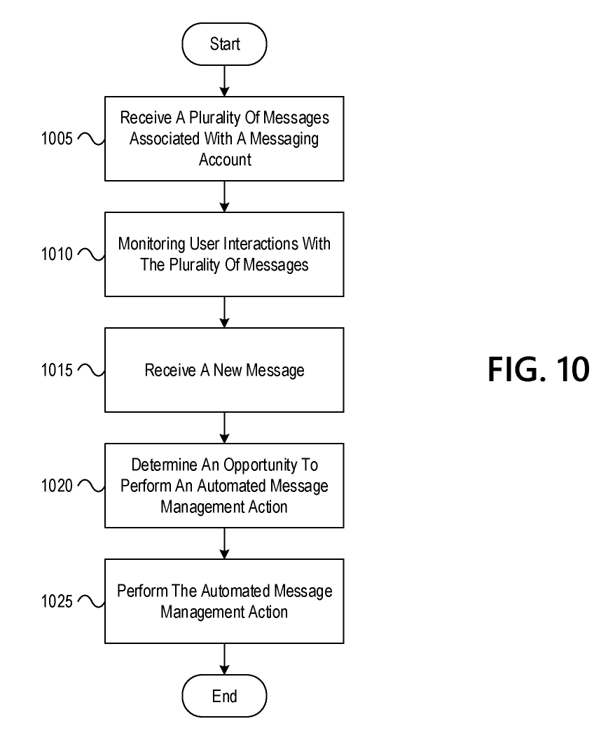

FIG. 10 depicts an illustrative method for performing one or more automated message management actions. Referring to FIG. 10, at step 1005, a computing platform having at least one processor, a memory, and a communication interface may receive, via the communication interface, a plurality of messages corresponding to a messaging account. At step 1010, the computing platform may monitor, via the communication interface, one or more user interactions with the plurality of messages. At step 1015, the computing platform may receive, via the communication interface, a new message. At step 1020, the computing platform may determine, based at least in part on the one or more user interactions with the plurality of messages, an opportunity to perform an automated message management action associated with the new message. At step 1025, the computing platform may perform the automated message management action.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
receive, via the communication interface, a plurality of messages corresponding to a messaging account;
monitor, via the communication interface, one or more user interactions with the plurality of messages;
receive, via the communication interface, a new message;
determine, based at least in part on the one or more user interactions with the plurality of messages, an opportunity to perform an automated message management action associated with the new message; and
perform the automated message management action.

2. The computing platform of claim 1, wherein to determine the opportunity to perform the automated message management action associated with the new message, the memory stores computer-readable instructions that, when executed by the at least one processor, cause the computing platform to:
analyze the plurality of messages and the monitored one or more user interactions with the plurality of messages;
train, based on the analysis, one or more machine learning models; and
determine, based on analyzing the new message using the one or more machine learning models, the opportunity to perform the automated message management action associated with the new message.

3. The computing platform of claim 2, wherein at least one of the one or more machine learning models is configured to determine a priority score of the new message, the priority score indicating an importance of the new message to a user associated with the messaging account.

4. The computing platform of claim 3, wherein the priority score is based at least in part on a first position within an organization of a sender of the new message relative to a second position within the organization of the user associated with the messaging account.

5. The computing platform of claim 3, wherein the priority score is based at least in part on one or more of a topic associated with the new message, one or more keywords within the new message, and a sentiment of the new message.

6. The computing platform of claim 3, wherein the priority score is based at least in part on other recipients of the new message.

7. The computing platform of claim 3, wherein to perform the automated message management action, the memory stores computer-readable instructions that, when executed by the at least one processor, cause the computing platform to:
rank the new message within the plurality of messages according to the priority score.

8. The computing platform of claim 2, wherein the plurality of messages comprises a first message, wherein the monitored one or more user interactions comprise a second message sent in response to the first message, and wherein to analyze the plurality of messages and the monitored one or more user interactions with the plurality of messages, the memory stores computer-readable instructions that, when executed by the at least one processor, cause the computing platform to:
determining a response time between receiving the first message and sending the second message; and
determining, based on the response time, a priority associated with the first message.

9. The computing platform of claim 1, wherein to perform the automated message management action, the memory stores computer-readable instructions that, when executed by the at least one processor, cause the computing platform to:
generate an automatic response to the new message.

10. The computing platform of claim 9, wherein the automatic response includes scheduling information describing an availability of a user associated with the messaging account.

11. The computing platform of claim 1, wherein to perform the automated message management action, the memory stores computer-readable instructions that, when executed by the at least one processor, cause the computing platform to:
automatically un-subscribe to a mailing list associated with the new message.

12. The computing platform of claim 1, wherein to perform the automated message management action, the memory stores computer-readable instructions that, when executed by the at least one processor, cause the computing platform to:
automatically send a notification to a user associated with the messaging account, the notification indicating that the user has not responded to the new message.

13. The computing platform of claim 1, wherein to perform the automated message management action, the memory stores computer-readable instructions that, when executed by the at least one processor, cause the computing platform to:
categorize the new message.

14. The computing platform of claim 1, wherein to perform the automated message management action, the memory stores computer-readable instructions that, when executed by the at least one processor, cause the computing platform to:
suggest one or more recipients to add to or remove from a response message to be sent in response to the new message.

15. The computing platform of claim 1, wherein to perform the automated message management action, the memory stores computer-readable instructions that, when executed by the at least one processor, cause the computing platform to:
generate a user interface comprising a summary of the new message and one or more summaries of other messages that are similar to the new message.

16. The computing platform of claim 1, wherein the memory stores computer-readable instructions that, when executed by the at least one processor, cause the computing platform to:
generate a user interface comprising a summary of the automated message management action;
receive a user input indicating an approval of the automated message management action; and
update, based on the user input, one or more machine learning models.

17. A method comprising:
receiving, by at least one processor of a computing platform, via a communication interface, a plurality of messages corresponding to a messaging account;
monitoring, by the at least one processor, via the communication interface, one or more user interactions with the plurality of messages;
receiving, by the at least one processor, via the communication interface, a new message;
determining, by the at least one processor, based at least in part on the one or more user interactions with the plurality of messages, an opportunity to perform an automated message management action associated with the new message; and
performing, by the at least one processor, the automated message management action.

18. The method of claim 17, wherein determining the opportunity to perform the automated message management action associated with the new message comprises:
analyzing the plurality of messages and the monitored one or more user interactions with the plurality of messages;
training, based on the analyzing, one or more machine learning models; and
determining, based on analyzing the new message using the one or more machine learning models, the opportunity to perform the automated message management action associated with the new message.

19. The method of claim 17, further comprising:
generating, by the at least one processor, a user interface comprising a summary of the automated message management action;
receiving, by the at least one processor, a user input indicating an approval of the automated message management action; and
updating, by the at least one processor, based on the user input, one or more machine learning models.

20. One or more non-transitory computer-readable media storing instructions that, when executed by a computing platform comprising at least one processor, memory, and a communication interface, cause the computing platform to:
receive, via the communication interface, a plurality of messages corresponding to a messaging account;
monitor, via the communication interface, one or more user interactions with the plurality of messages;
receive, via the communication interface, a new message;
determine, based at least in part on the one or more user interactions with the plurality of messages, an opportunity to perform an automated message management action associated with the new message; and
perform the automated message management action.
